(19) United States
(12) Patent Application Publication
(10) Pub. No.: US 2011/0305519 A1
(43) Pub. Date: Dec. 15, 2011

(54) SYSTEM AND PROCESS FOR EX-SITU SOIL REMEDIATION

(75) Inventors: Kenneth M. Haberman, St. Paul, MN (US); Paul R. Book, Northfield, MN (US); Matthew L. Ledvina, Maplewood, MN (US); Sharon E. Paradise, St. Paul, MN (US)

(73) Assignee: SOIL RECYCLING OF MINNESOTA, LLC, St. Paul, MN (US)

(21) Appl. No.: 13/155,541

(22) Filed: Jun. 8, 2011

Related U.S. Application Data
(60) Provisional application No. 61/353,541, filed on Jun. 10, 2010.

(51) Int. Cl. B09C 1/00; G06F 7/00

(52) U.S. Cl. 405/128.1; 700/214

(57) ABSTRACT

The present invention relates generally to systems and processes for ex-situ reformulation of contaminated soil to reduce contaminant concentrations below target criteria. An ex-situ reformation system for reducing the concentration of contaminants contained in a material includes a user interface and a decision engine configured to receive a plurality of input parameters from the user interface relating to each of two or more different material stockpiles available for reformulation. The decision engine is configured to determine a quantity of each stockpile for reducing an amount of processing required to perform the reformulation.

### CROSS-REFERENCE TO RELATED APPLICATION

This application claims priority under 35 U.S.C. §119 to U.S. Provisional Application No. 61/353,541, filed Jun. 10, 2010, entitled “SYSTEM AND PROCESS FOR EX-SITU SOIL REMEDIATION,” which is incorporated herein by reference in its entirety for all purposes.

### TECHNICAL FIELD

The present invention relates generally to soil remediation. More specifically, the present invention pertains to systems and processes for ex-situ reformulation of contaminated soil to reduce contaminant concentrations below target criteria.

### BACKGROUND

In the past, soil excavated from previously developed properties was used to fill low-lying areas, such as ravines and wetlands. Little to no attention was paid at the time to the quality of the fill material disposed of in this manner. This disposal method, in many cases, led to contamination of soil and water resources and restricted the land use from future development without remediation. In recent years, however, this situation has dramatically changed. Today, soil that is excavated from commercial or industrial properties is routinely sampled and analyzed to determine its chemical characteristics prior to that soil being transported off of a project site. Likewise, a growing number of owners of commercial and industrial properties are now requiring that any soil that will be imported to their site be tested prior to being accepted as “clean fill” to limit their future liability.

Over the years, public policies have been developed and programs established to encourage individuals, businesses, and governmental agencies to reduce, reuse and recycle. As a result of these initiatives, many different types of materials are now recycled. One type of material that is not being recycled in significant quantities, however, is the soil excavated from numerous commercial and industrial properties during redevelopment as well as soil excavated in connection with some public infrastructure projects. A significant quantity of soil excavated from these types of projects is not reused on-site often because there is simply no room for it to be reused on-site. In this instance, and provided the soil is suitable for reuse from a structural standpoint, most developers or excavation contractors will try to find another property that can reuse the soil. However, if the excavated soil is not suitable for reuse at another property and/or there is no property owner willing to accept the soil at the time based on potential liability concerns, the only option that may be available to ensure that the redevelopment or construction project stays on schedule is to transport the soil to a permitted landfill for disposal. This situation arises regardless of whether the excavated soil is marginally contaminated, if the soil is clean, or if the soil meets the regulatory definition of “unregulated fill”.

A number of public policies and programs are now in place that encourage the redevelopment of commercial and industrial properties in an environmentally sound and sustainable manner. These properties are often referred to as brownfields. Over the past two decades, many state government agencies developed voluntary cleanup programs to provide regulatory and technical assistance to parties willing to purchase and redevelop brownfields. Over the past ten years, the federal government has also taken a more active role in promoting brownfield redevelopment. One of the first steps taken to provide technical assistance to parties willing to voluntarily implement response actions to remediate contaminated soil has involved publishing numeric health risk-based criteria. These criteria are often based in part on the current and proposed land use classifications such as residential, recreational, commercial and industrial. These criteria help define the concentrations and conditions by which the soil will not pose a risk to human health or the environment. These target criteria also help define the concentrations and conditions by which the soil needs to be regulated, which typically involves properly characterizing, managing, and/or remediating the soil.

As a result of the adoption of heath risked-based approaches for making contaminant cleanup decisions, contaminated soil that was previously sent off-site or placed in a landfill could in some cases be reused on-site following redevelopment, provided the contaminated soil does not pose an unacceptable risk to human health or the environment based on the current and planned future use of the property, and provided the contaminant soil that remained on-site was not disturbed. Risk-based cleanups are frequently chosen as an acceptable alternative for avoiding the high costs of having the soil excavated, transported, and disposed of in a landfill. In these circumstances, however, the property owner is typically obligated to file an institutional control with the government. The institutional control requires that the property owner comply with certain long-term reporting, monitoring, and/or maintenance requirements as well as possible land-use restrictions. These institutional controls would also apply to any subsequent property owners. In some cases, the long term consequence of these institutional controls can result in on-going reporting obligations and costs, a reduction in property value as well as limit future property development.

As a current standard practice, representative samples of the soil to be excavated in connection with the redevelopment of commercial and industrial properties and public infrastructure projects are collected and analyzed by a laboratory to determine if the soil is contaminated by either organic or inorganic chemicals. The laboratory analytical results are then compared to applicable health risk-based criteria established by the regulatory agency. Based on these results, not all soil can be managed in the same manner, and as a result, different soil risk-based scenarios may be present. In some cases, for example, there may be five soil risk-based concentration/management scenarios each dependent on the number, type and concentration of the contaminant present in a given soil source. Soil may be deemed “clean” if all analytical results show contaminant concentrations are below laboratory detection levels or do not exceed natural background concentrations. “Un-regulated” soil may contain contaminant concentrations below “un-restricted” criteria, which is often suitable for use on residential properties. “Marginally-contaminated” soil may comprise soil contaminated with concentrations above residential criteria but below that of criteria established for use on commercial and industrial property. “Contaminated” soil may comprise soil contaminated with concentrations above commercial and industrial criteria, in some cases requiring the soil to be disposed of at a non-hazardous waste permitted landfill. “Hazardous” soil, in turn, may comprise soil containing contaminants at concentrations such that the soil is required to be transported to a permitted hazardous waste disposal or processing facility.

In general, it is likely soil will remain at a project site if it is capable of being reused and the laboratory results determine that the soil is clean. The soil can also remain on site if the soil is determined to be contaminated but meets the future land use criteria. In such cases, however, the property owner or prospective purchaser must be willing to comply with certain reporting requirements and/or land-use restrictions (e.g., institutional controls), as previously discussed. In these cases, it is possible that the soil will be transported to a landfill even if the laboratory results indicate that the soil meets applicable risk-based criteria suitable for commercial and industrial properties since many property owners or prospective purchasers often prefer to avoid the requirements and the perceived property devaluation associated with institutional controls. If there is no room on the property to reuse the soil because the redevelopment plans call for excavation and no importing of fill soil (e.g., an underground parking garage or a basement), it is likely that the excavated soil will be transported to a landfill. The potential for this outcome increases if the property has been subject to prior regulatory review regardless of whether the laboratory results indicate that the soil meets applicable risk-based criteria for commercial and industrial properties, or is clean. This is a matter of convenience, reducing project delays and avoiding regulatory and economic risk.

Schedules are often critical for redevelopment or construction projects. It is difficult to stay on budget if the project schedule is significantly delayed. This applies to all aspects of the project, including the excavation work. If the developer or excavation contractor cannot find another property that can reuse the soil that is being excavated, subsequent construction work on the project could be delayed. As a result, timing between various construction projects is often a factor that needs to be considered. Ideally, the soil would be transported to another property that needs soil or fill and the property owner is willing to accept the soil or fill from another commercial or industrial property. In a number of cases, the redevelopment schedules of two projects (one with excess fill and one that needs fill) do not mesh well or the property owner is not willing to accept the soil even if the laboratory results indicate that the soil meets the applicable health risk-based criteria. This scenario often results in the soil being sent to a landfill.

In some cases, the soil may be transported to a landfill irrespective of the costs associated with transportation or disposal. For example, the soil may be transported to a landfill due to the stigma that is sometimes associated with soil that originates from previously redeveloped properties or “sites of regulatory interest”. Even if the laboratory results are able to document that the soil is clean (e.g., meeting the most conservative criteria), if the property is a previously developed commercial, industrial or site of regulatory interest, the soil could still end up being transported to a landfill since no other property owner may be willing to accept the soil.

The cost of soil transportation and landfill disposal continues to increase. The cost of purchasing and transporting “clean fill” likewise continues to increase. As a result, there is an ongoing need for an ex-situ soil reformulation process as an alternative to other techniques such as soil disposal.

### SUMMARY

The present invention relates generally to systems and processes for ex-situ reformulation of contaminated soil to reduce contaminant concentrations below target criteria. An example ex-situ soil reformulation process for reducing contaminants in soil comprises determining the mass of soil for each of a plurality of discrete soil stockpiles; determining the concentration of one or more contaminants contained in each soil stockpile; converting the contaminant concentrations for each contaminant to obtain an equivalent mass of contaminant present within each soil stockpile; comparing the one or more contaminants identified in each soil stockpile against a target criteria; designating at least one soil stockpile and an associated quantity of soil for performing a soil reformulation; outputting the designated soil stockpiles and associated soil quantities to a user or process for performing the soil reformulation; and combining one or more designated soil stockpiles together to achieve contaminant soil concentrations below the target criteria.

An example ex-situ soil reformulation system for reducing the concentration of contaminants contained in material comprises a user interface and a decision engine configured to receive a plurality of input parameters from the user interface relating to each of two or more different soil stockpiles available for soil reformulation. In some embodiments, the decision engine is configured to determine a quantity of each soil stockpile for reducing an amount of processing required to perform the soil reformulation.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 is a schematic diagram showing an illustrative system for reducing the concentration of contaminants contained in soil; and

FIG. 2 is a flow chart showing an illustrative ex-situ reformulation process for reducing contaminant concentrations in soil.

While the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

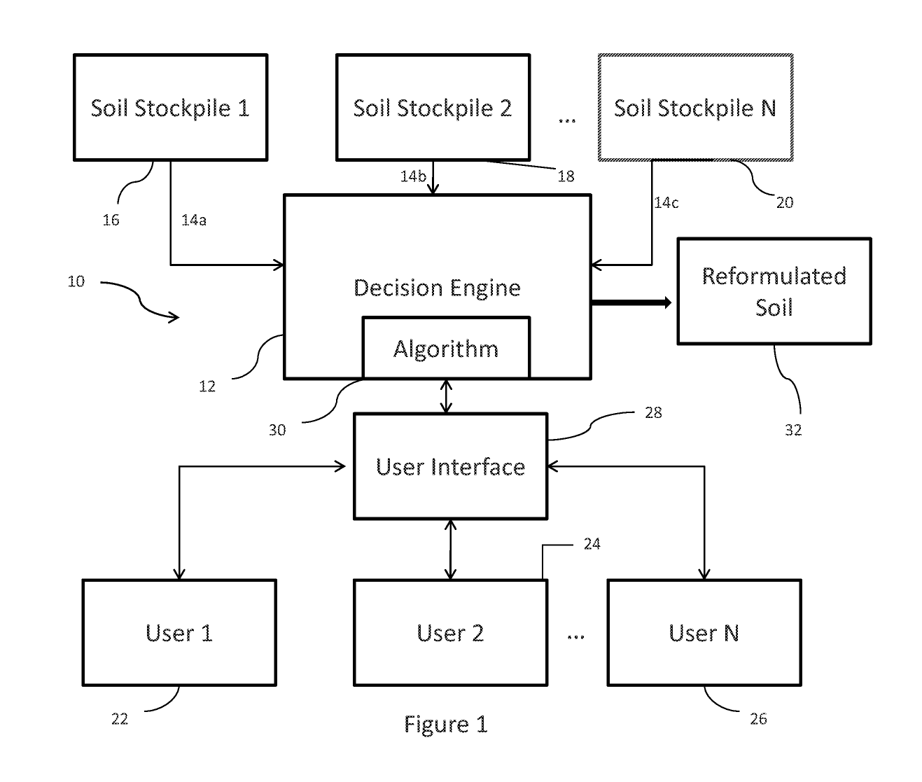

FIG. 1 is a schematic diagram showing an illustrative system 10 for reducing the concentration of contaminants contained in soil. In some embodiments, for example, the system 10 may comprise a system for reducing the concentration of identified contaminants contained in soil based on health risk-based criteria established by an environmental regulatory agency or other target criteria. As shown in FIG. 1, the system 10 comprises a decision engine 12 configured to receive a number of input parameters 14a,14b,14c relating to each of two or more different soil stockpiles 16,18,20 available for soil reformulation. In some embodiments, for example, the decision engine 12 may comprise a computer software program (e.g., a spreadsheet, database, etc.) and/or hardware (e.g., a hand-held device, laptop computer, etc.) that receives as input parameters 14a,14b,14c the mass of each discrete soil stockpile 16,18,20 available to the system 10 as well as the mass percentage (or equivalent volume) of any contaminants contained within each stockpile 16,18,20. In certain embodiments, the decision engine 12 may comprise a computer software program operable over a personal computer, an intranet, and/or the Internet, and which can be accessed by one or more users 22,24,26 via a user interface 28. The contaminants within each soil stockpile 16,18,20 can be analyzed and determined using conventional laboratory tests, either on-site or at another facility. In some embodiments, the soil stockpiles 16,18,20 can contain one or more types of inorganic and/or organic contaminants that can be verified using certified analytical testing methods.

The decision engine 12 can be configured to track multiple, discrete stockpiles 16,18,20 of soil each with their own physical and chemical characteristics. As discussed further herein, the system 10 can be used for ex-situ processing of soil obtained irrespective of source or origin. In some embodiments, the system 10 may be utilized on-site, at a soil reformulation site, or other off-site location to permit the ex-situ reformulation of soil, in some cases across multiple, ongoing soil reformulation projects. Any number of soil stockpiles 16,18,20 can be analyzed, allowing the system 10 to be scaled to size depending on those stockpiles 16,18,20 currently available for soil reformulation.

The decision engine 12 can be configured to run an algorithm or routine 30 that computes a mass balance calculation based on the mass of each soil stockpile 16,18,20 and the amount (e.g., percentage) of each contaminant contained therein. In some embodiments, the decision engine 12 can be accessed by one or more users 22,24,26 to determine the quantity of each discrete soil stockpile 16,18,20 to combine together in order to reduce contaminant soil concentrations below an operator-specified or other target criteria.

From the various input parameters 14a,14b,14c to the system 10, the decision engine 12 can identify which soil stockpiles 16,18,20 can be combined together and in which quantities so that the resulting reformulated soil 32 falls below or meets target criteria, including the health risk-based criteria established by regulatory agencies. In some embodiments, the decision engine 12 may employ an optimization algorithm or routine 22 that determines the quantity of each discrete soil stockpile 16,18,20 needed in order to reduce or minimize the amount of processing required to perform the soil reformulation. In some embodiments, for example, linear or non-linear programming techniques can be utilized to minimize the operating time associated with reformulating the soil, thereby reducing the total cost and environmental footprint associated with completing a particular soil remediation project.

Once the decision engine 12 determines which soil stockpiles 16,18,20 and associated quantities are necessary to perform the soil reformulation, the soil can then be processed either on-site or at another facility. For example, the soil can be reformulated at a fixed facility or at a project site using conventional soil handling and blending equipment commonly found at construction sites and at sand and gravel operations. Once reformulated, the soil 30 can be recycled as fill back to the project site from which it was obtained or resold to a new project site, as desired. By recycling the soil, the system 10 avoids the unnecessary disposal of soil in landfills and the long-term regulatory requirements or land-use restrictions related to institutional controls.

Although the system 10 is described in conjunction with the remediation of contaminated soil, in other embodiments the system 10 can be used in the remediation of other materials containing one or more contaminants. For example, the system 10 could be used for remediating other types of aggregate, semisolids, or other material containing contaminants above a target criteria.

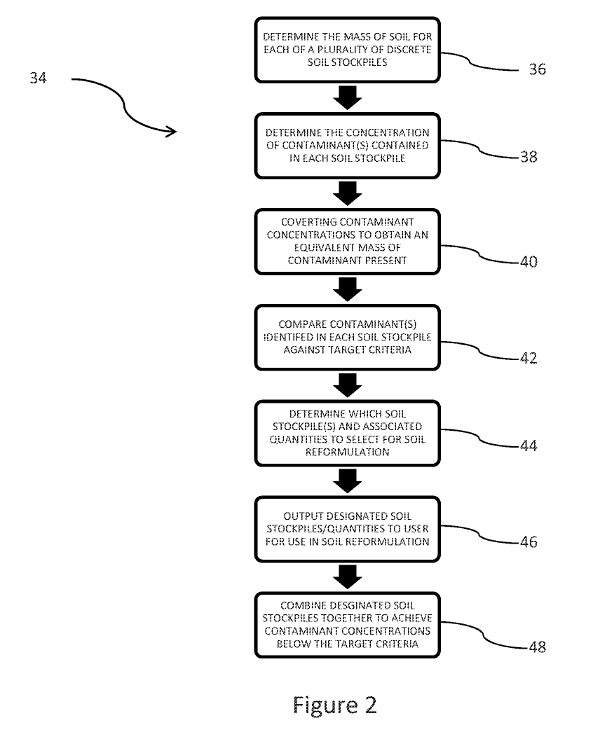

FIG. 2 is a flow chart showing an illustrative ex-situ reformulation process 34 for reducing contaminant concentrations in soil. The process 34 may comprise, for example, several illustrative steps that can be performed by the decision engine 12 of FIG. 1 for ex-situ processing a number of different soil stockpiles 16,18,20 for soil reformulation using a soil blending technique. The process 34 can begin generally at block 36, by determining the mass of soil by weighing each of a plurality of different soil stockpiles. In some embodiments, each soil stockpile is quantified and characterized in terms of mass expressed in tons.

For each stockpile, the process 34 also includes the step of quantitatively determining the concentration of contaminants contained in each soil stockpile (block 38). The contaminants within each soil stockpile can be expressed as a concentration in parts per million (ppm), which is equivalent to milligrams (mg) of contaminant per unit kilogram of soil mass. The value for the soil mass can be obtained by weighing the soil stockpile on a scale on-site, at the soil reformulation facility, or at another location. The contaminant concentration, in turn, can be obtained on-site or at a licensed analytical laboratory using known sampling and testing quality assurance and quality control procedures. These quantitative parameters can then be inputted as input parameters 14a,14b,14c to the decision engine 12 (e.g., as input fields to a user interface 28), as discussed above with respect to FIG. 1.

From these input parameters, and as further shown at block 40, a contaminant concentration for each soil stockpile may then be obtained and converted into an equivalent mass of contaminant present. In some embodiments, the contaminant concentration may be converted into a percentage value by multiplying the reported concentration value by a value such as 0.0001. The mass of the soil stockpile containing the concentration can then be multiplied by the resulting percentage to obtain the equivalent mass of the contaminant present contained in each soil sample, which can be expressed in tons. By calculating the mass to mass ratio of the contaminants present in each discrete soil stockpile, a soil blending calculation may be performed by the decision engine 12 that identifies which discrete soil stockpiles can be combined such that the resulting reformulated soil mass falls below or meets an operator specified or other target criteria.

The mass of the contaminant(s) contained in each soil stockpile can then be compared against target criteria in order to determine whether the level of contaminant(s) contained in the soil stockpile exceeds a target value (block 42). In certain embodiments, the target criteria may be based on compiling regulatory health-risk based criteria at the location where the project is to occur (e.g., based on state and/or federal environmental regulations), based on project-specific criteria inputted by the user, or based on some other desired criteria.

Using the target criteria, the decision engine 12 may then determine which stockpiles and associated quantities to select for soil reformulation (block 44). In some embodiments, the decision engine 12 may optimize one or more input parameters so that the amount of soil reformulation required to blend the soil stockpiles together is reduced or minimized. The input parameters to the decision engine 12, including the selection of the desired target criteria for comparison against the actual contaminant levels as well as the mass and physical attributes of the soil stockpiles can be set via an interface 28 (e.g., a graphical user interface) and stored in memory. The results from the decision engine 12 may then be outputted to a user or process for later use in the soil reformulation process (block 46).

The user may then physically combine the requisite contaminated soil stockpiles to achieve concentrations below the targeted (e.g., health risk-based) criteria (block 48). In some embodiments, this may include the use of mobile and stationary soil handling and soil screening equipment (e.g., front end loaders, screens, and conveyors) or the use of mobile and stationary to uniformly blend the soil and scales to determine and verify the mass of the reformulated soil. Once the target criteria are achieved, the reformulated soil may then be reused on a project site.

The ex situ reformulation process 34 may reduce the net concentration of contaminants in a measured quantity of soil by reformulating soil from multiple project sites, or from one project site with multiple sources of soil that contain contaminants, until the contaminants fall below prescribed concentrations. In some embodiments, the process of analyzing the mass and contaminant concentrations can be performed iteratively as different soil stockpiles are added and removed from the system 10. This allows the decision engine 12 to continuously adjust the selection of soil stockpiles and associated quantities based on information currently available to the system 10. In some embodiments, the iterative process may utilize multiple input fields, including published regulatory health risk-based criteria, verifiable laboratory analytical results, accurate estimates of soil quantities, the physical properties of the soil, as well as other factors.

In use, the ex-situ soil reformulation process 34 may permit contaminated soil to be recycled back to project sites as an alternative to landfill disposal. The reformulation process 34 is not limited by the source of soil, the physical or chemical characteristics of the soil, or a given established regulatory criteria. In addition, the process 34 allows an operator to manage the contaminated waste soil in a manner that promotes recycling and sustainable (i.e., green) practices to protect valuable resources. Use of the reformulation process 34 also avoids the necessity of employing long-term reporting obligations land use restrictions on a project site, keeps project costs and time within acceptable criteria, and effectively recycles the product by avoiding its disposal in a landfill.

In some embodiments, the process 34 may involve only the combination of soil with unlike contaminants. In other embodiments, multiple soil sources with the same contaminants can be combined provided the mass concentrations of contaminants present is sufficiently low when compared to the mass of the soils. In some embodiments, clean soil is not used in the reformulating process. In other embodiments, clean soil can be used in the reformulation process. For example, the process 34 can incorporate uncontaminated soil for modifying the reformulated fill to meet a desired specification and/or to utilize excess soil that would otherwise be landfilled. In some cases, clean soil can be added to contaminated soil stockpiles once the soil reformulation process has been successfully completed. The ex situ reformulation process 34 may reduce the net concentration of contaminants in a measured quantity of soil by reformulating soil from multiple project sites, or from one project site with multiple sources of soil that contain contaminants, until the contaminants fall below target criteria.

### Example

An incoming new soil source (50 tons) is delivered to a soil reformulation facility having 3 existing soil stockpiles on site. The new soil stockpile is inventoried as “soil pile 4”. The soil is sampled and sent to a laboratory. Laboratory analytical results indicate two contaminants are present above the standard method detection limits at the laboratory: Barium (Ba) is present at 10 ppm (mg/kg) and selenium (Se) is present at 5 ppm (mg/kg). Converting these two metals to a contaminant percentage results in values of 0.001 and 0.0005, respectively. Based on a 50 ton soil mass, there is 0.050 tons of barium and 0.025 tons of selenium present in the incoming soil source. This data is compiled in the following spreadsheet (Table 1):

TABLE 1
Soil pile 4
Incoming soil source
Quantity: 50 tons

| | | | | mass of |
|---|---|---|---|---|
| | | | equivalent | contaminant |
| Contaminant | lab result | | as a percent | in pile (tons) |
| As | 0 | ppm | 0 | 0.000 |
| Ba | 10 | ppm | 0.001 | 0.050 |
| Cd | 0 | ppm | 0 | 0.000 |
| Cr (total) | 0 | ppm | 0 | 0.000 |
| Hg | 0 | ppm | 0 | 0.000 |
| Pb | 0 | ppm | 0 | 0.000 |
| Se | 5 | ppm | 0.0005 | 0.025 |
| PAH (total) | 0 | ppm | 0 | 0.000 |

Three existing soil stockpiles (1 through 3) have been previously characterized and are stored for reformulation use at the soil reformulation facility. Soil stockpiles 1 through 3 mass and chemical signature results are shown below in Table 2.

TABLE 2

| | | | |
|---|---|---|---|
| | | | mass of |
| | | equivalent | contaminant |
| Contaminant | lab result | as a percent | in pile (tons) |

Soil pile 1
Stockpile soil pile 1
Quantity: 10 tons

| | | | | |
|---|---|---|---|---|
| As | 1 | ppm | 0.0001 | 0.001 |
| Ba | 0 | ppm | 0 | 0.000 |
| Cd | 10 | ppm | 0.001 | 0.010 |
| Cr (total) | 0 | ppm | 0 | 0.000 |
| Hg | 1.5 | ppm | 0.00015 | 0.002 |
| Pb | 0 | ppm | 0 | 0.000 |
| Se | 0 | ppm | 0 | 0.000 |
| PAH (total) | 0 | ppm | 0 | 0.000 |

Soil pile 2
Stockpile soil pile 2
Quantity: 35 tons

| | | | | |
|---|---|---|---|---|
| As | 0 | ppm | 0 | 0.000 |
| Ba | 30 | ppm | 0.003 | 0.105 |
| Cd | 0 | ppm | 0 | 0.000 |
| Cr (total) | 6 | ppm | 0.0006 | 0.021 |
| Hg | 0 | ppm | 0 | 0.000 |
| Pb | 0 | ppm | 0 | 0.000 |
| Se | 0 | ppm | 0 | 0.000 |
| PAH (total) | 0 | ppm | 0 | 0.000 |

Soil pile 3
Stockpile soil pile 3
Quantity: 200 tons

| | | | | |
|---|---|---|---|---|
| As | 0 | ppm | 0 | 0.000 |
| Ba | 0 | ppm | 0 | 0.000 |
| Cd | 0 | ppm | 0 | 0.000 |
| Cr (total) | 0 | ppm | 0 | 0.000 |
| Hg | 0 | ppm | 0 | 0.000 |
| Pb | 25 | ppm | 0.0025 | 0.500 |
| Se | 0 | ppm | 0 | 0.000 |
| PAH (total) | 0 | ppm | 0 | 0.000 |

Many state regulatory agencies have developed health risk-based criteria that establish the maximum concentration of a given contaminant that can be present in soil (at concentrations measured in mg/kg) if it is to be placed on a residential property. State regulatory agencies have also established commercial/industrial criteria. While the example provided is described in terms of residential criteria for the soil reformulation process, in other embodiments the process can be configured to use industrial/commercial criteria or other project-specific criteria, if desired.

In this example, the soil will be reformulated to a concentration below residential criteria and will be sold for reuse at commercial/industrial sites eliminating the need for the institutional controls required if the soil was reformulated to meet the industrial/commercial criteria. Table 3 below is a list of example organic and inorganic contaminants and exemplary residential target values. Any of the following fields can be changed within the process based on the specific locale where the reformulation process is to occur.

TABLE 3

| Contaminant | mg/kg |
|---|---|
| As | 9.0 |
| Ba | 842.0 |
| Cd | 4.4 |
| Cr (total) | 87.0 |
| Hg | 0.5 |
| Pb | 9.0 |
| Se | 1.5 |
| PAH (total) | 2.0 |

Of the four stockpiles managed in this example, the concentrations of barium (Ba) and chromium (Cr [total]) do not exceed the applicable criteria. However, the concentrations of selenium (Se) and lead (Pb) in the example do exceed the applicable criteria. Combining the four soil stockpiles without reformulation utilizing conventional soil blending techniques yields a composite mass of 295 tons and the following tabulated soil mass concentrations:

TABLE 4
Soil Class
Reformulation of soil piles 1-4 Iteration A
Quantity of Soil in Blended Pile 295 tons

| | | | | | Calculated combined | | |
|---|---|---|---|---|---|---|---|
| | Mass of contaminant | | | | contaminant level | | |
| | in pile (tons) | | | | composite | composite | composite |
| Contaminant | pile 4 | pile 1 | pile 2 | pile 3 | pile (tons) | pile (%) | pile (mg/kg) |
| As | 0.0000 | 0.001 | 0.000 | 0.000 | 0.00 | 0.00000 | 0.03 |
| Ba | 0.0500 | 0.000 | 0.105 | 0.000 | 0.16 | 0.00053 | 5.25 |
| Cd | 0.0000 | 0.010 | 0.000 | 0.000 | 0.01 | 0.00003 | 0.34 |
| Cr (total) | 0.0000 | 0.000 | 0.021 | 0.000 | 0.02 | 0.00007 | 0.71 |
| Hg | 0.0000 | 0.002 | 0.000 | 0.000 | 0.00 | 0.00001 | 0.05 |
| Pb | 0.0000 | 0.000 | 0.000 | 0.500 | 0.50 | 0.00169 | 16.95 |
| Se | 0.0250 | 0.000 | 0.000 | 0.000 | 0.03 | 0.00008 | 0.85 |
| PAH (total) | 0.0000 | 0.000 | 0.000 | 0.000 | 0.00 | 0.00000 | 0.00 |

During the reformulation process 34, the decision engine 12 (e.g., at step 42) compares the results in the last column in Table 4 with the relevant state regulatory criteria compiled in the example as in Table 3. Table 5 (see below) shows that the four masses combined result in an exceedance of the promulgated standard for lead (Pb):

TABLE 5
Exceedance of Standard in the Reformulated Soil Stockpile

| | | Regulatory | |
|---|---|---|---|
| | Composite Pile | Criteria | Is the criteria |
| Contaminant | Conc. (mg/kg) | (mg/kg) | exceeded? |
| As | 0.03 | 9.0 | No |
| Ba | 5.25 | 842.0 | No |
| Cd | 0.34 | 4.4 | No |
| Cr (total) | 0.71 | 87.0 | No |
| Hg | 0.05 | 0.5 | No |
| Pb | 16.95 | 9.0 | Yes |
| Se | 0.85 | 1.5 | No |
| PAH (total) | 0.00 | 2.0 | No |

Reformulation using the process 34 shows that by blending 39 tons of soil stockpile 4 with all of soil stockpiles 1 and 2, and 47 tons of soil stockpile 3 provides the following results:

TABLE 6
Reformulation of soil piles 1-4 Iteration 2
Quantity of Soil in Blended Pile 131 tons

| | | | | | Calculated combined | | |
|---|---|---|---|---|---|---|---|
| | Mass of contaminant | | | | contaminant level | | |
| | in pile (tons) | | | | composite | composite | composite |
| Contaminant | pile 4 | pile 1 | pile 2 | pile 3 | pile (tons) | pile (%) | pile (mg/kg) |
| As | 0.0000 | 0.001 | 0.000 | 0.000 | 0.00 | 0.00001 | 0.08 |
| Ba | 0.0390 | 0.000 | 0.105 | 0.000 | 0.14 | 0.00110 | 10.99 |
| Cd | 0.0000 | 0.010 | 0.000 | 0.000 | 0.01 | 0.00008 | 0.76 |
| Cr (total) | 0.0000 | 0.000 | 0.021 | 0.000 | 0.02 | 0.00016 | 1.60 |
| Hg | 0.0000 | 0.002 | 0.000 | 0.000 | 0.00 | 0.00001 | 0.11 |
| Pb | 0.0000 | 0.000 | 0.000 | 0.118 | 0.12 | 0.00090 | 8.97 |
| Se | 0.0195 | 0.000 | 0.000 | 0.000 | 0.02 | 0.00015 | 1.49 |
| PAH (total) | 0.0000 | 0.000 | 0.000 | 0.000 | 0.00 | 0.00000 | 0.00 |

The soils have been successfully reformulated so that there is no regulatory exceedance as the following table indicates:

TABLE 7
Exceedance of Standard in the Reformulated Soil Stockpile

| | | Regulatory | |
|---|---|---|---|
| | Composite Pile | Criteria | Is the criteria |
| Contaminant | Conc. (mg/kg) | (mg/kg) | exceeded? |
| As | 0.08 | 9.0 | No |
| Ba | 10.99 | 842.0 | No |
| Cd | 0.76 | 4.4 | No |
| Cr (total) | 1.60 | 87.0 | No |
| Hg | 0.11 | 0.5 | No |
| Pb | 8.97 | 9.0 | No |
| Se | 1.49 | 1.5 | No |
| PAH (total) | 0.00 | 2.0 | No |

In this case, the soil reformulation facility will have 11 tons of stockpile 4 and 153 tons of stockpile 3 remaining to be utilized in future reformulation processes.

What is claimed is:

1. An ex-situ reformulation process for reducing contaminants in soil, the process comprising:
determining the mass of soil for each of a plurality of discrete soil stockpiles;
determining the concentration of one or more contaminants contained in each soil stockpile;
converting the contaminant concentrations for each contaminant to obtain an equivalent mass of contaminant present within each soil stockpile;
comparing the one or more contaminants identified in each soil stockpile against a target criteria;
designating at least one soil stockpile and an associated quantity of soil for performing a soil reformulation;
outputting the designated soil stockpiles and associated soil quantities to a user or process for performing the soil reformulation; and
combining one or more designated soil stockpiles together to achieve contaminant soil concentrations below the target criteria.

2. The process of claim 1, wherein combining one or more designated soil stockpiles together to achieve contaminant soil concentrations below the target criteria includes a soil blending technique.

3. The process of claim 1, wherein the target criteria comprises a regulatory health-risk based criteria.

4. The process of claim 1, wherein the target criteria comprises a project-specific criteria inputted into a user interface.

5. The process of claim 1, further comprising a decision engine configured to compare the one or more contaminants and designating at least one soil stockpile and an associated quantity of soil for performing the soil reformulation.

6. The process of claim 5, wherein the decision engine is configured to compute a mass balance calculation based on the mass of each soil stockpile and the amount of each contaminant contained in each soil stockpile.

7. An ex-situ reformation system for reducing the concentration of contaminants contained in a material, the system comprising:
a user interface; and
a decision engine configured to receive a plurality of input parameters from the user interface relating to each of two or more different stockpiles available for reformulation;
wherein the decision engine is configured to determine a quantity of each stockpile for reducing an amount of processing required to perform the reformulation.

8. The system of claim 7, wherein the decision engine is configured for computing a mass balance calculation based on the mass of each stockpile and the amount of each contaminant contained within each stockpile.

9. The system of claim 7, wherein the plurality of input parameters includes the mass of each stockpile and the mass percentage or equivalent volume of any contaminants contained within each stockpile.

10. The system of claim 7, wherein the decision engine is configured to track multiple, discrete stockpiles.

11. The system of claim 7, wherein the plurality of stockpiles includes one or more types of inorganic or organic contaminants.

12. The system of claim 7, wherein the stockpiles are soil stockpiles.

13. The system of claim 7, wherein the decision engine is configured for optimizing the one or more input parameters the reduce the reformulation required to blend the stockpiles together.

14. An ex-situ soil reformulation system for reducing the concentration of contaminants contained in soil, the system comprising:
a user interface; and
a decision engine configured to receive a plurality of input parameters from the user interface relating to each of two or more different soil stockpiles available for soil reformulation;
wherein the decision engine is configured to determine a quantity of each soil stockpile for reducing an amount of processing required to perform the soil reformulation.

15. The system of claim 14, wherein the decision engine is configured for computing a mass balance calculation based on the mass of each soil stockpile and the amount of each contaminant contained within each soil stockpile.

16. The system of claim 14, wherein the decision engine is configured to compare the one or more contaminants identified in each soil stockpile against a target criteria.

17. The system of claim 14, wherein the plurality of input parameters includes the mass of each soil stockpile and the mass percentage or equivalent volume of any contaminants contained within each stockpile.

18. The system of claim 14, wherein the decision engine is configured to track multiple, discrete soil stockpiles.

19. The system of claim 14, wherein the plurality of soil stockpiles includes one or more types of inorganic or organic contaminants.

20. The system of claim 14, wherein the decision engine is configured for optimizing the one or more input parameters the reduce the soil reformulation required to blend the soil stockpiles together.
